(19) United States
(12) Patent Application Publication
(10) Pub. No.: US 2015/0154419 A1
(43) Pub. Date: Jun. 4, 2015

(54) COMPUTER ECOSYSTEM WITH DIGITAL RIGHTS MANAGEMENT (DRM) TRANSFER MECHANISM

(71) Applicant: SONY CORPORATION, Tokyo (JP)

(72) Inventor: JASON CLEMENT, San Diego, CA (US)

(73) Assignee: SONY CORPORATION, Tokyo (JP)

(21) Appl. No.: 14/095,029

(22) Filed: Dec. 3, 2013

(51) Int. Cl. G06F 21/62

(52) U.S. Cl. CPC G06F 21/6218

(57) ABSTRACT

A user who purchases content can transfer rights in the content to another user when the first user is finished viewing the content. The transfer may be to provide both users with access to a downgraded version of the content, or providing the transferee user access to a high resolution version of the content while terminating the first user's access to the content.

### FIELD OF THE INVENTION

The present application relates generally to computer ecosystems and more particularly to digital rights management (DRM) transfer mechanisms

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

Present principles are directed to specific aspects of computer ecosystems, specifically, allowing a user who owns entitlements to a piece of content that the user no longer is interested in, to transfer some or all of those rights to another individual.

### SUMMARY OF THE INVENTION

Present principles accordingly are directed to allowing a user to transfer a portion or all of the user's entitlement rights for a specific piece of content to one or more individuals based on a point system that indicates how many times the user is allowed to transfer a particular piece of content. When depleted, points can be replenished by purchasing additional points thus allowing additional transfers to be made. In an embodiment, the transfer mechanism contacts a digital rights management (DRM) server and requests authorization for the transfer. An entitlement is allowed to be transferred to another individual or device if an appropriate number of points associated with that particular piece of content exists.

Accordingly, a device includes at least one computer readable storage medium bearing instructions executable by a processor and at least one processor configured for accessing the computer readable storage medium to execute the instructions to configure the processor for allocating, to an original user of content requiring credentials to view, transfer credits to facilitate transferring rights in the content to a friend. Responsive to a transfer signal from a device associated with the original, the processor transfers at least rights to view the content to a friend designated by the original user, rendering the content unavailable to the original user. A transfer credit amount is charged in an account of the original user to account for the transferring.

If desired, the content can be rendered unavailable by removing or otherwise disabling credentials of the original user necessary to view the content, or by deleting or erasing the content from at least one device associated with the original user, or by replacing the content with a downgraded version of the content on at least one device associated with the original user.

In some examples, the processor when executing the instructions is configured for allocating the transfer credits to the original user along with providing the content to the original user. The processor when executing the instructions may be configured for allocating the transfer credits to the original user responsive to receiving transfer credit payment from the original user in addition to receiving payment for the content from the original user. In non-limiting examples, the processor when executing the instructions is configured for allocating the transfer credits to the original user responsive to receiving payment for the content from the original user without requiring further transfer credit payment from the original user.

In another aspect, a method includes presenting, on a video display, a user interface (UI) including at least a share selector element selectable to obtain transfer credits as part of a cost payable by a user for content to be transferred or for remuneration in addition to the cost of content to be transferred. A complete transfer selector is presented that is selectable to designate that the content with access credentials is to be provided to a transferee while rendering the content unavailable to the user. As well, a downgrade transfer selector is presented that is selectable to designate the transferee to receive at least a version of the content while providing the user access to a downgraded version only of the content.

In another example, a system includes at least one computer readable storage medium bearing instructions executable by a processor which is configured for accessing the computer readable storage medium to execute the instructions to configure the processor for receiving from a first user having access rights to first content in a higher resolution version a signal evincing a desire of the first user to transfer rights in the first content to a second user. Responsive to a determination that rights to first content are to be allocated between the first and second user, the processor provides to the second user access to a lower resolution version of the first content along with any necessary credentials to view the content, making available only the lower resolution version, but not the higher resolution version, of the first content to the first user for viewing. On the other hand, responsive to a determination that rights to the first content are to be allocated entirely to the second user, the processor provides access to the second user, along with any necessary credentials, access to the higher resolution version, removing access of the first user to the first content.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flowchart of example overall logic; and

FIGS. 3-5 are example user interfaces (UI) that may be used attendant to the present logic.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic using structure such as various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

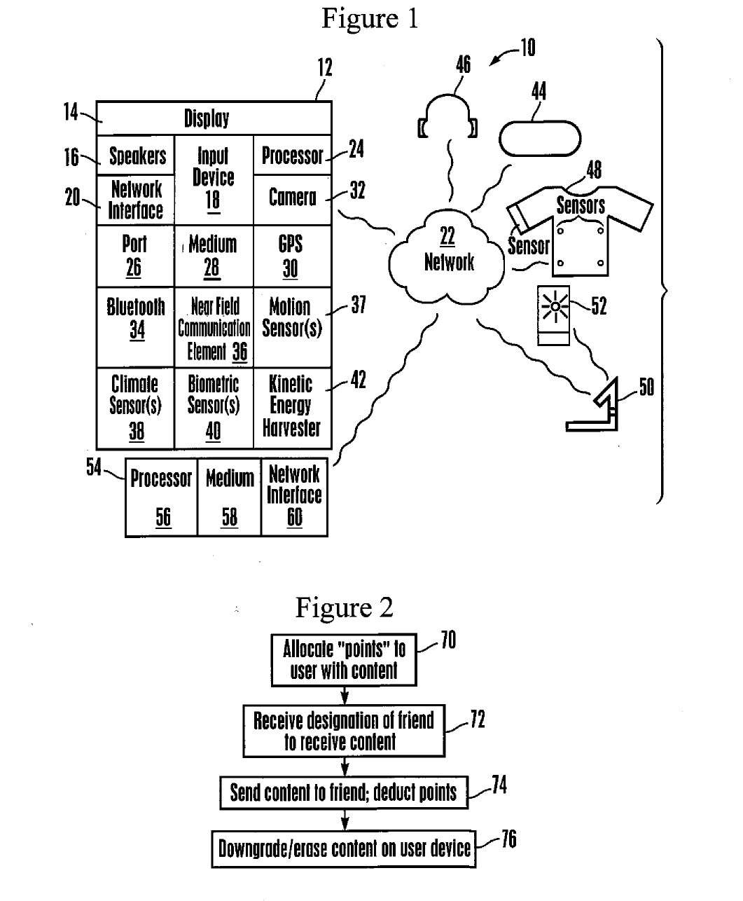

Now specifically referring to FIG. 1, an example system 10 is shown, which may include one or more of the example devices mentioned above and described further below in accordance with present principles. The first of the example devices included in the system 10 is an example consumer electronics (CE) device 12 that may be waterproof (e.g., for use while swimming). The CE device 12 may be, e.g., a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc., and even e.g. a computerized Internet-enabled television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can be established by some or all of the components shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles. Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the CE device 12 may include one or more motion sensors 37 (e.g., an accelerometer, gyroscope, cyclometer, magnetic sensor, infrared (IR) motion sensors such as passive IR sensors, an optical sensor, a speed and/or cadence sensor, a gesture sensor (e.g. for sensing gesture command), etc.) providing input to the processor 24. The CE device 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that in some embodiments the CE device 12 may also include a kinetic energy harvester 42 to e.g. charge a battery (not shown) powering the CE device 12.

Still referring to FIG. 1, in addition to the CE device 12, the system 10 may include one or more other CE device types such as, but not limited to, a computerized Internet-enabled bracelet 44, computerized Internet-enabled headphones and/or ear buds 46, computerized Internet-enabled clothing 48, a computerized Internet-enabled exercise machine 50 (e.g. a treadmill, exercise bike, elliptical machine, etc.), etc. Also shown is a computerized Internet-enabled entry kiosk 52 permitting authorized entry to a space. It is to be understood that other CE devices included in the system 10 including those described in this paragraph may respectively include some or all of the various components described above in reference to the CE device 12 such but not limited to e.g. the biometric sensors and motion sensors described above, as well as the position receivers, cameras, input devices, and speakers also described above.

Now in reference to the afore-mentioned at least one server 54, it includes at least one processor 56, at least one tangible computer readable storage medium 58 that may not be a carrier wave such as disk-based or solid state storage, and at least one network interface 60 that, under control of the processor 56, allows for communication with the other CE devices of FIG. 1 over the network 22, and indeed may facilitate communication between servers and client devices in accordance with present principles. Note that the network interface 60 may be, e.g., a wired or wireless modem or router, WiFi transceiver, or other appropriate interface such as, e.g., a wireless telephony transceiver.

Accordingly, in some embodiments the server 54 may be an Internet server, may include and perform “cloud” functions such that the CE devices of the system 10 may access a “cloud” environment via the server 54 in example embodiments.

Now referring to FIG. 2, which shows logic that may be implemented by any of the processors above alone or in combination (and typically is performed at least by a cloud-based content management server such as the server 54), at block 70 an original user is allocated usage or transfer points along with content purchased by the original user. As described further below, these points permit the original user to transfer some or all of the user's digital management rights (DRM) in the purchased content to another user.

Upon such time as the original, purchasing user decides he is finished with the content, at block 72 a signal may be received from a CE device associated with the original, purchasing user that the original user has designated another user (referred to as “friend” for ease of description) to receive DRM in the content provided at block 70. The content along with the necessary DRM credentials are sent to the friend at block 74, and transfer points duly deducted from the original user's account.

In some embodiments, the transfer is made only if the number of transfer points in the user's account meets a threshold. If the user does not have enough points the transfer may be denied. In contrast, if surplus points are available, the necessary amount of points are deducted, leaving a remainder for use in transferring other content to friends, or in transferring the same content to recipient friends apart from the transferee friend receiving the first transfer of the content rights.

Then at block 76 the content may be downgraded to a lower resolution or deleted/erased altogether or otherwise made unavailable on the device of the original user to which the content had been sent at block 70 by, e.g., deleting the DRM credentials from the user's device or changing the DRM credentials to new credentials sent to the receiving friend device. Note that thereafter, the “friend” may subsequently stand in the place of the original user and repeat the logic of FIG. 2 for secondary transfers, which may be repeated for tertiary transfers, and so on.

In an example, suppose User A has ten points associated with Content 1 which is an entitlement to an HD quality movie. User A can transfer the Content 1 to User B for five points and retain five points. Because rights have been split between the two users the entitlement has been degraded to a SD quality movie. Each user can upgrade to a HD quality movie by purchasing five additional points.

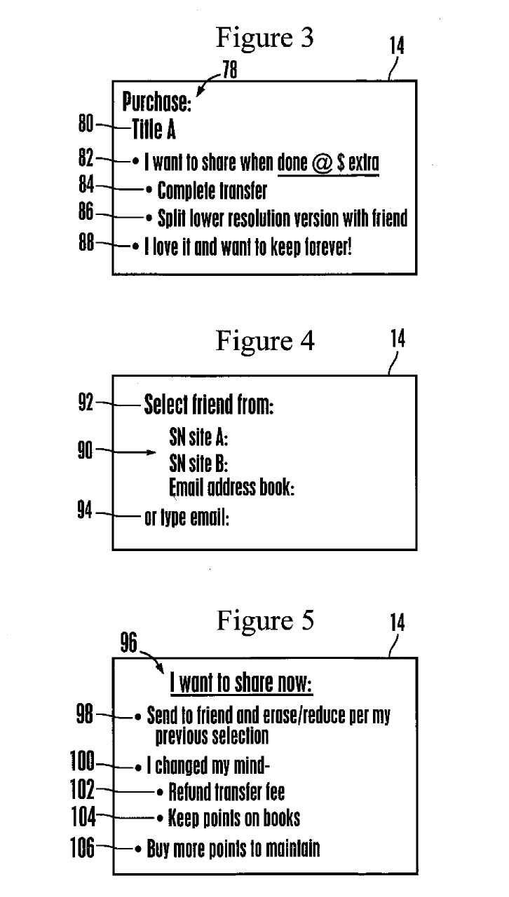

FIG. 3 shows an example user interface (UI) 78 that may be presented on the display 14 of a CE device of the original user to purchase content requiring DRM credentials. The title 80 of the content is presented along with a share selector element 82 that may be selected by the user (using, e.g., an input device such as touchscreen capability of the display 14) to obtain transfer points. If desired, these transfer points may be provided to the original user as part of the cost of the content, or the user may be charged extra (as shown in the example UI of FIG. 3) for the transfer points.

Selection of the share selector 82 may be further accompanied by a complete transfer selector 84, which a user may select to cause (later, in the present example) the content with DRM credentials to be transferred entirely to a transferee friend, erasing or deleting or otherwise rendering the content unavailable thereafter to the original user. Also, selection of the share selector 82 may be further accompanied by a downgrade transfer selector 86, which a user may select to cause (later, in the present example) the transferee friend to receive the content in the same resolution as the content version purchased by the original user or in a downgraded resolution compared to the resolution of the content version purchased by the original user, with the original user being provided, in the example shown, with a downgraded version of the content of the content and with the user's original higher resolution version being made unavailable to the original user. Yet again, a selector 88 may be provided in which the original user may select not to share the content and, thus, not to receive transfer points (or pay for them in embodiments in which points are not provided as part of the purchase price for the content).

Assuming the original user has selected to share the content at some future date, the UI 90 of FIG. 4 may be presented to allow the user to identify the friend or friends with whom the original user wishes to share the content. A selector 92 may be provided to enable a user to access a friend list from one or more social network sites of the user, which list(s) may be stored on the user's CE device or accessed from the respective site(s) over the Internet responsive to the selection of the selector 92 to cause the list to be presented on the CE device, from which the original user may select one or more friends with accompanying network addresses. The user may also or alternately select a selector 94 to enter a friend address such as an email address or other address.

When the user decides he has enjoyed the content purchased at block 70 a satisfactory amount and wishes to transfer his rights in the content to the friend(s) selected from the example UI of FIG. 4, the user may cause his CE device to present the UI 96 of FIG. 5 which, like the other UIs discussed herein, may be provided from the cloud content management server which sourced the content at block 70. Note that the various UI principles discussed herein may be combined into fewer UIs or spread over a larger number of UIs. A selector 96 may be provided to enable the original user to cause the content along with the necessary DRM credentials to be sent to the friend(s) devices selected from FIG. 4. The content may be transmitted from the CE device of the original user to the friend device or it may be downloaded from the content management server to the friend device. The selector 98 can indicate to the original user that the original user's content will be made unavailable or, if selected by the user from FIG. 3, downgraded to a lower resolution version.

Selection of the selector 98 causes the content to be downgraded or made unavailable on the original user's device. When the content is to be downgraded, a newer lower resolution version may be downloaded from the content management server to the device of the original user and the higher resolution version of the content made unavailable, e.g., by any of the example methods described previously or other appropriate method. The content in either its higher resolution or downgraded resolution version as selected by the user or provided by system protocol is downloaded from the content management server to the friend device(s), or, as mentioned above, sent directly peer-to-peer from the device of the original user to the friend device(s), along with any necessary DRM credentials to access the content.

In the example UJI shown, the user can select a selector 100 indicating that the user no longer harbors the intent to transfer the content. In this case, the user may be permitted to select a selector 102 to refund the transfer fee, if any, that was previously paid when the content was purchased by the original user. Or, the user may select a selector 104 to maintain the transfer points in the original user's account managed by the content management server for use in transferring other titles.

A selector 106 may also be provided that a user can select to purchase additional points necessary to both maintain the originally purchased content in its high resolution format and to transfer the content to a friend. In other words, should the user decide he wants to share the content but also maintain access to it himself, he may pay more for the privilege, receiving any new or extended DRM credentials as a result. A point purchase UI may be presented to facilitate a network purchase of additional points.

While the particular COMPUTER ECOSYSTEM WITH DIGITAL RIGHTS MANAGEMENT (DRM) TRANSFER MECHANISM is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
allocating, to an original user of content requiring credentials to view, transfer credits to facilitate transferring rights in the content to a friend;
responsive to a transfer signal from a device associated with the original, transferring at least rights to view the content to a friend designated by the original user;
rendering the content unavailable to the original user; and
changing a transfer credit amount in an account of the original user to account for the transferring.

2. The device of claim 1, wherein the content is rendered unavailable by removing or otherwise disabling credentials of the original user necessary to view the content.

3. The device of claim 1, wherein the content is rendered unavailable by deleting or erasing the content from at least one device associated with the original user.

4. The device of claim 1, wherein the content is rendered unavailable by replacing the content with a downgraded version of the content on at least one device associated with the original user.

5. The device of claim 1, wherein the processor when executing the instructions is configured for allocating the transfer credits to the original user along with providing the content to the original user.

6. The device of claim 1, wherein the processor when executing the instructions is configured for allocating the transfer credits to the original user responsive to receiving transfer credit payment from the original user in addition to receiving payment for the content from the original user.

7. The device of claim 1, wherein the processor when executing the instructions is configured for allocating the transfer credits to the original user responsive to receiving payment for the content from the original user without requiring further transfer credit payment from the original user.

8. Method comprising:
presenting, on a video display, a user interface (UI) including at least a share selector element selectable to obtain transfer credits as part of a cost payable by a user for content to be transferred or for remuneration in addition to the cost of content to be transferred;
a complete transfer selector selectable to designate that the content with access credentials is to be provided to a transferee while rendering the content unavailable to the user; and
a downgrade transfer selector selectable to designate the transferee to receive at least a version of the content while providing the user access to a downgraded version only of the content.

9. The method of claim 8, wherein selection of the downgrade transfer selector designates the transferee to receive a version of the content in a downgraded resolution format compared to a resolution format of the content paid for by the user.

10. The method of claim 8, wherein selection of the downgrade transfer selector designates the transferee to receive a version of the content in a resolution format that is the same as a resolution format of the content paid for by the user.

11. The method of claim 8, comprising presenting a selector selectable to cause the content along with the necessary DRM credentials to be sent to the transferee according to whether the complete transfer selector or the downgrade transfer selector was selected.

12. The method of claim 8, comprising presenting a selector selectable to facilitate purchase by the user of additional credits necessary to both maintain the user's access to the content in a high resolution format and to transfer the content to a friend.

13. System comprising:
at least one computer readable storage medium bearing instructions executable by a processor which is configured for accessing the computer readable storage medium to execute the instructions to configure the processor for:
receiving from a first user having access rights to first content in a higher resolution version a signal evincing a desire of the first user to transfer rights in the first content to a second user;
responsive to a determination that rights to first content are to be allocated between the first and second user, providing to the second user access to a lower resolution version of the first content along with any necessary credentials to view the content, and making available only the lower resolution version, but not the higher resolution version, of the first content to the first user for viewing; and
responsive to a determination that rights to the first content are to be allocated entirely to the second user, providing access to the second user, along with any necessary credentials, access to the higher resolution version and removing access of the first user to the first content.

14. The system of claim 13, wherein the processor when executing the instructions is further configured for:
responsive to a determination that rights to first content are to be allocated between the first and second user, charging an account of the first user “N” credits.

15. The system of claim 14, wherein the processor when executing the instructions is further configured for:
responsive to a determination that rights to first content are to be allocated entirely to the second user, charging an account of the first user “M” credits, wherein M does not equal N.

16. The system of claim 13, wherein the processor when executing the instructions is further configured for:
responsive to a determination that rights to first content are to be allocated between the first and second user, crediting an account of the second user “N” credits.

17. The system of claim 13, wherein the processor when executing the instructions is further configured for:
responsive to a determination that the first or second user has purchased additional credits, upgrading rights of the first or second user who purchased additional credits to view the content in the higher resolution format.

18. The system of claim 13, wherein the processor when executing the instructions is further configured for:
allocating the credits to the first user along with providing the content to the first user.

19. The system of claim 13, wherein the processor when executing the instructions is configured for allocating the credits to the first user responsive to receiving transfer credit payment from the first user in addition to receiving payment for the content from the first user.
